(19) United States
(12) Patent Application Publication
(10) Pub. No.: US 2009/0127427 A1
(43) Pub. Date: May 21, 2009

(54) Form panel doubling as substrate for interior and exterior materials and form construction method for concrete structure

(76) Inventor: Kenkichi Sato, Aomori (JP)

Correspondence Address: Kazunao Kubotera;Takeuchi & Kubotera, 200 Daingerfield Road Suite 202, Alexandria, VA, 22314, US

(21) Appl. No.: 11/921,271

(22) PCT Filed: Jun. 2, 2006
(86) PCT No.: PCT/JP2006/311112

§ 371 Date: Nov. 29, 2007

(30) Foreign Application Priority Data
Jun. 3, 2005 (JP) 2005-192780
Oct. 4, 2005 (JP) 2005-318813

(51) Int. Cl. B28B 7/00; E04B 1/16

(52) U.S. Cl. 249/13; 52/745.19; 52/742.14

(57) ABSTRACT

It is an object of the invention to provide a form panel 1 doubling as a substrate for interior and exterior materials, in which a square-bar like substrate member 4 for interior and exterior materials is formed on a concrete framework after curing concrete. In order to attain the above object, according to the invention, longitudinal grooves 3 having a square U-bottomed cross-section are formed in a surface of the form panel 2. The square bar-like substrate members 4 for interior and exterior materials are inserted in the longitudinal grooves 3. While only the form panel 2 is removed after casting concrete, only the substrate material for the interior and exterior material is secured on the concrete framework part.

### FIELD OF THE INVENTION

The present invention relates to a substrate for interior and exterior materials and a form panel used for concrete formwork in construction work, and a form construction method including installation of the substrate for interior and exterior materials.

### BACKGROUND TECHNOLOGY

In a construction method using a concrete form, after casting concrete into a concrete building framework and removing a form therefrom, a substrate material is assembled with a wood frame on the concrete casting surface, and interior and exterior materials are secured thereon by nailing. Alternatively, light-gauge steel is assembled, and then interior and exterior materials are secured thereon with screws. Alternatively, an adhesive is applied in balls, and then interior and exterior materials are directly secured by pressure bonding or other method.

In addition, when thermal insulation work is performed, concrete is casted while a thermal insulation board comprised of foamed synthetic resin is nailed in advance onto an inner surface of a sheathing. Then, after curing the concrete, by removing only plywood, a thermal insulation concrete wall is formed. Afterward, a substrate material for interior and exterior materials is assembled, so that the interior and exterior materials are attached thereto.

As described above, in the concrete formwork, after casting concrete, securing work to secure interior and exterior members is required. In recent years, a sheathing is used as a substrate for interior and exterior materials as a rational method. In this construction method, a foamed plastic thermal insulation board, in which a foamed plastic thermal insulation material is adhered to a wood wool board or a new building material board, is used as a sheathing of a concrete form, which can be also used as a substrate for interior and exterior materials. After casting concrete, without removing the sheathing, finishing of the interior and exterior materials is done on a surface thereof. Since the thermal insulation board is used as the sheathing in this construction method, thermal insulation work can be also performed at the same time.

### DISCLOSURE OF THE INVENTION

### Problems to be Solved by the Invention

The above method, however, has the following problems. The sheathing used in formwork is required to have enough rigidity and strength against deformation, breakage, and so on. Because of a low strength of the panel itself, the foamed plastic thermal insulation material that composes the sheathing has to have a larger thickness or has to be adhered and integrated with another composite board, so that financial burden is larger. In addition, for actual construction, there are also many issues regarding carrying members in a construction site for the formwork, labor cost, transportation cost, and storage of materials, etc.

These problems are aroused since the sheathing that requires a strength is used as the substrate. However, it is still desired to maintain an advantage of forming the interior and exterior substrate on the concrete framework at the time of casting concrete in view of rationalizing the work steps.

In view of the problems described above, an object of the invention is to achieve a construction method, in which a sheathing is not used as interior and exterior substrates, and a substrate member for interior and exterior materials is separated from the sheathing and is formed on the concrete framework after casting concrete.

### Means to Solve the Problems

In order to attain the objects described above, according to the present invention, a form panel 1 doubling as a substrate for interior and exterior materials has the following configuration.

A sheathing surface of a concrete form panel has a plurality of longitudinal grooves having a rectangular cross-section, so as to provide rigidity as a sheathing of the concrete form panel. For a material to compose the form, a material having high rigidity is used in view of strength, deflection, a spacing between horizontal lumbers, and so on. In addition, substrate members in a square bar shape for interior and exterior materials are fitted in the longitudinal grooves. Here, the square bar shape includes a hollow shape, for example, C-form steel. The substrate for interior and exterior materials also works as a reinforcing material against a side pressure upon casting concrete and a vertical lumber. More specifically, in order to increase the strength and rigidity of the form panel, the longitudinal grooves having a rectangular cross-section are formed in the surface thereof. The substrate members in a square bar shape for interior and exterior materials are fitted in the longitudinal grooves. Then, the substrate members are secured from a backside of the longitudinal grooves with screws. Accordingly, the substrate members for interior and exterior materials are integrated thereto as a reinforcing material against a concrete side pressure.

The substrate member for interior and exterior materials may have an anchoring section in a surface exposed from the sheathing. Therefore, the anchoring section of the substrate member for interior and exterior materials is surely secured onto the concrete framework after casting concrete, thereby preventing the substrate members from peeling off.

Screw holes may be formed in bottoms of the longitudinal grooves of the concrete form panel at arbitrary intervals for securing the substrate members in a square bar shape for interior and exterior materials, so as to increase efficiency of the work. Here, it is preferred that the substrate members in a square bar shape for interior and exterior materials have a certain range of rigidity that enables securing nails, screws, and so on, or have female screws formed therein in advance. A separator holes may be formed in the longitudinal grooves, and the substrate members for interior and exterior materials may have a separator hole at a corresponding position.

As a construction method, when no thermal insulation work is performed, the substrate members for interior and exterior materials are fitted in the plurality of longitudinal grooves in a center part of the sheathing of the concrete form. Then, the substrate members for interior and exterior materials are secured with nails, screws or the like, so as to form the form panel doubling as the substrate for interior and exterior materials. The panel is assembled into a specified shape at a construction site and casting concrete therein, so that the concrete framework is molded. Thereafter, dissembling the form and releasing the fastening between the substrate members for interior and exterior materials and a plastic board by removing screws and so on, and the form panel is removed while leaving the substrate members for interior and exterior materials in the concrete framework. Thereafter, using the remaining substrate members for interior and exterior materials as a foundation, interior and exterior work is performed.

Where thermal insulation work is performed, the substrate members for interior and exterior materials made of C-form steel are fitted in the longitudinal grooves formed in the sheath surface of the form panel, so that the form panel doubling as the substrate for interior and exterior materials is formed. Then, a heat insulation board is attached to the concrete casting surface, and the form panel doubling as the substrate for interior and exterior materials is secured on the backside thereof. Thereafter, a separator is secured such that the separator pierces the substrate members for interior and exterior materials and the thermal insulation board from the backside of the form panel doubling as the substrate for interior and exterior materials, so that the separator is embedded in the concrete framework. Then, concrete is cast to mold the concrete framework. After curing concrete, while leaving the thermal insulation board and the substrate members for interior and exterior materials therein, the form panel is removed. Thereafter, a fastening member is inserted into the substrate members for interior and exterior materials, and the interior and exterior members are attached thereto.

Here, when there is unevenness on the wall surface, etc. after curing concrete, it is possible to adjust the unevenness by loosening nuts engaged with the separator that secures the substrate members for interior and exterior materials and inserting an intervening material, such as packing, between the thermal insulation board and the substrate members for interior and exterior materials.

### EFFECTS OF THE INVENTION

According to the present invention, with the above-described configuration, by fitting the substrate members in a square bar shape for interior and exterior materials in the plurality of longitudinal grooves having a rectangular cross-section provided on the center part of the sheathing, it is not necessary to use a conventional vertical lumbers in the formwork, thereby reducing transportation, assembling, and dissembling works. In addition, a complicated work of attaching the substrate members for interior and exterior materials can be also omitted, and steps in a work contents between the formwork and the work of attaching substrate members for interior and exterior materials can be rationalized, so that the steps can be shortened, and the cost can be significantly reduced.

In addition, when the thermal insulation board is secured, the substrate members for interior and exterior materials and the thermal insulation board can be surely secured and integrated to the concrete via the separator.

Furthermore, since a space as a hallow layer is generated between the substrate members for interior and exterior materials, the space can have effects of a ventilation layer to prevent dew condensation and have sound insulation, and also can be used as a space for piping and wiring.

### BRIEF DESCRIPTION OF THE DRAWINGS

FIG. 1 is a perspective view of a construction work state in a form construction method of a concrete formwork according to a first embodiment of the present invention;

FIG. 2 is a lateral sectional view of an installation state of interior and exterior materials in the form construction method of the concrete formwork according to the first embodiment;

FIG. 3 is a longitudinal sectional view of the construction work state in the form construction method of the concrete formwork according to the first embodiment;

FIG. 4 is a plan view of a substrate member for interior and exterior materials according to the first embodiment;

FIG. 5 is a side view of the substrate member for interior and exterior materials according to the first embodiment;

FIG. 6 is a perspective view of a construction work state in a form construction method of a concrete formwork according to a second embodiment of the present invention;

FIG. 7 is a lateral sectional view of the construction work state in the form construction method of the concrete formwork according to the second embodiment;

FIG. 8 is a lateral sectional view of a construction work state in the form construction method of the concrete formwork according to a modified example of the second embodiment;

FIG. 9 is an exploded lateral sectional view of a substrate member for interior and exterior materials, a fastening receiving material, and interior and exterior materials according to the second embodiment;

FIG. 10 is a perspective view of the substrate member for interior and exterior materials according to the second embodiment; and

FIG. 11 is a perspective view of the fastening receiving material according to the second embodiment.

### DESCRIPTION OF REFERENCE NUMERALS

Form panel doubling as a substrate for interior and exterior materials
2 Plastic board
3, 8 Longitudinal grooves
4, 7 Substrate material for an interior and exterior materials
5 Form panel
6 Thermal insulating board
9 Outer frame
10 Stiffener
11 Reinforcing stiffener
12 Fastening receiving material
13 Form tie hole
14 Separator hole
15 Nut
16 Fastening material (nail and screws)
A Screws
B Anchoring section
C Separator
D Screw hole
E Lateral lumber
F ventilation layer
G Concrete casting section
H Form tie

### BEST MODE OF CARRYING OUT THE INVENTION

### Embodiment 1

Hereunder, the first embodiment of the present invention will be explained.

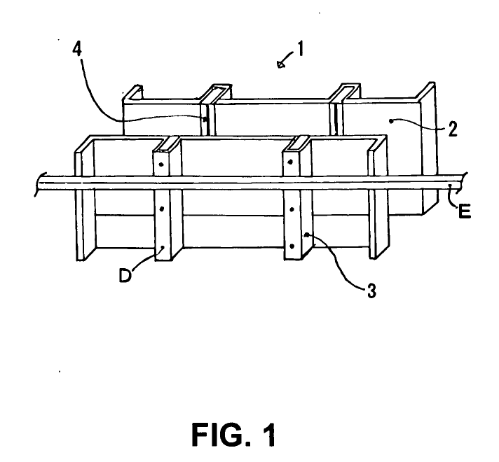

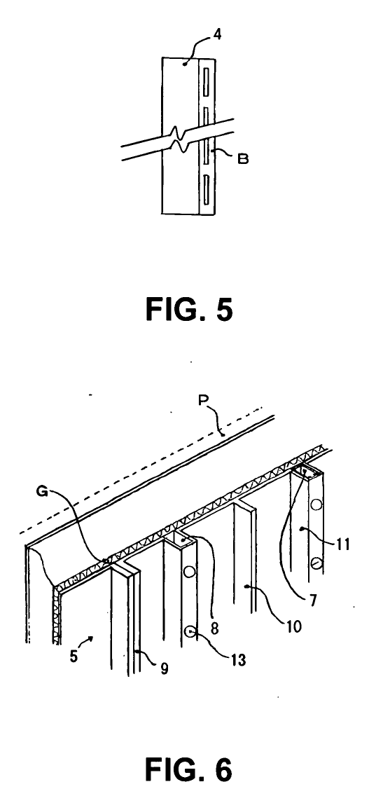

A plastic board that composes a form has a shape shown in FIG. 1. A sheathing has a thickness of 12 mm, a length of 3,000 mm, and a width of 600 mm, and has a plurality of longitudinal grooves 3 having a rectangular cross-section in a size so as to insert a square bar-like substrate member 4 for interior and exterior materials, at an interval of about 300 mm at a center portion of a surface thereof. A bottom surface of each longitudinal groove 3 has a plurality of screw holes D or through holes to put a nail or screw therein. Here, on a surface of the sheathing, in which the longitudinal grooves are not formed, a separator hole or a through hole for a separator is provided as necessary. The substrate member 4 for interior and exterior materials is formed to have a thickness of 30 mm, a length of 3,000 mm, and a width of 45 mm. FIG. 4 shows a side view of the substrate member 4 for interior and exterior materials, and FIG. 5 shows a plan view of the substrate member 4 for interior and exterior materials. As shown in FIGS. 4 and 5, one surface of the substrate member 4 for interior and exterior materials along a longitudinal direction thereof has a sheet-type anchoring section B having a plurality of rectangular holes, so as to protrude along the longitudinal direction. When the substrate member 4 for interior and exterior materials are fitted in the longitudinal grooves 3 of the sheathing, the substrate member 4 for interior and exterior materials are secured and integrated onto the sheathing with a nail or screw from a backside of the screw hole D. Accordingly, a form panel 1 doubling as a substrate for interior and exterior materials can be obtained. The form panel 1 doubling as a substrate for interior and exterior materials is normally not carried in a construction site, but rather formed at a factory or the like in advance and then carried in a construction site. Here, the above-described material, dimension, shape, and so on of the sheathing and the substrate member for interior and exterior materials are not intended to specifically limit.

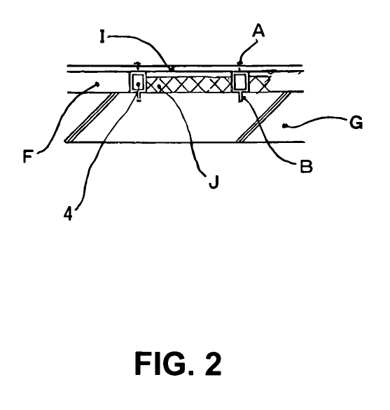

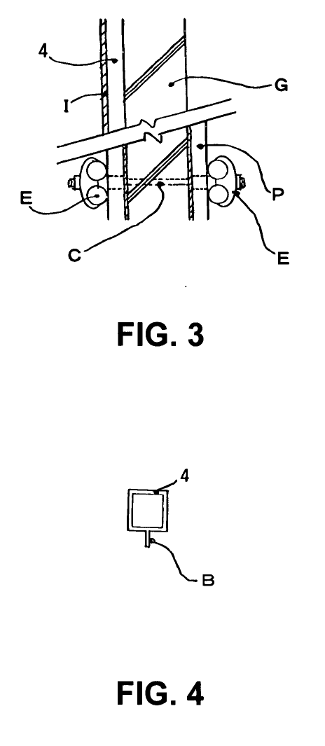

In the next step, the form panel 1 doubling as a substrate for interior and exterior materials is carried and constructed in the site. Then, a separator C, a form tie, and so on are attached to the form panel 1 doubling as substrate for interior and exterior materials as shown in FIGS. 1 and 3. Then, lateral lumbers E are provided at specified intervals, and secured with a support. Afterward, concrete is cast in, rested, and cured followed by removing the support. In this state, as shown in FIG. 2, the anchoring section B of the substrate member for interior and exterior materials is embedded and secured in the concrete framework G. Thereafter, removing screws A from the backside of the longitudinal grooves 3 of the sheathing 2 and leaving the square bar-like substrate member 4 for interior and exterior materials in the concrete framework G, only the sheathing 2 is removed. Then, as shown in FIG. 2, an interior and exterior material I is secured on the remaining substrate member 4 for interior and exterior materials with screws A, and finished. Here, as shown in FIG. 2, a space or a hallow layer is generated between a surface of the concrete framework and the substrate material I for interior and exterior materials. This portion can be expected to have effects of preventing moisture condensation, sound insulation, and so on as a ventilation layer F. In addition, any type of heat insulation material J can be installed on a concrete surface of the portion by advance-installation or later-installation to make a thermal insulation structure.

According to the form construction method of the invention, since the construction work from the formwork to the installation of the substrate for interior and exterior materials can be done consistently as described above, the work steps can be significantly simplified.

With the form panel 1 doubling as a substrate for interior and exterior materials, an interior material and an exterior material can be finished at the same time. In addition, for the formwork as shown in FIG. 3, the form panel 1 doubling as a substrate for interior and exterior materials is used on one side of the concrete casting side, and any conventional sheathing P (plywood, metallic, plastic or hardboard, and foamed plastic thermal insulating board, etc.) can be used on the opposite side depending on a use.

### Embodiment 2

Hereunder, the second embodiment of the invention will be described.

A form panel 5 has a shape shown in FIG. 6. A sheathing has a thickness of about 12 mm, a length of about 3 m, and a width of about 600 mm. An interval between a plurality of longitudinal grooves 8 provided in the center part of the surface is about 300 mm. A substrate member 7 for interior and exterior materials has a thickness of about 1.2 mm, a width of about 45 mm, and a length of about 3 m. The dimensions including those of an outer form 9, a stiffener 10, and a fastening receiving material 12 are not specifically limited by the above dimensions.

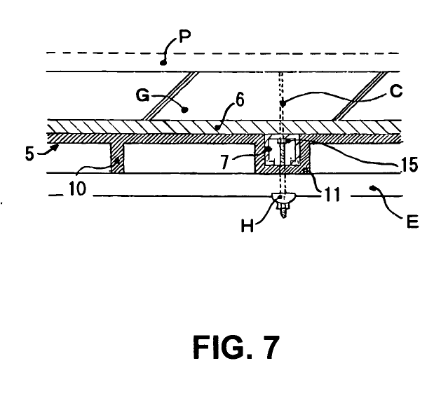

In the form panel 5 according to the embodiment shown in FIGS. 6 and 7, the heat insulation board 6 is set on a concrete casting surface, and the substrate member 7 for interior and exterior materials shown in FIG. 10 can fit in the plurality of longitudinal grooves 8 provided in the sheathing. Therefore, through their synergetic effects, it can work as a reinforcing member to reinforce a strength against a side pressure from the concrete G. Furthermore, the outer forms 9 that can connect to form boards are provided on the both edges. In addition, at a middle part of a backside of the sheathing, reinforcing stiffeners 11 comprised of a plurality of stiffeners and longitudinal grooves 8 are provided at a specified interval.

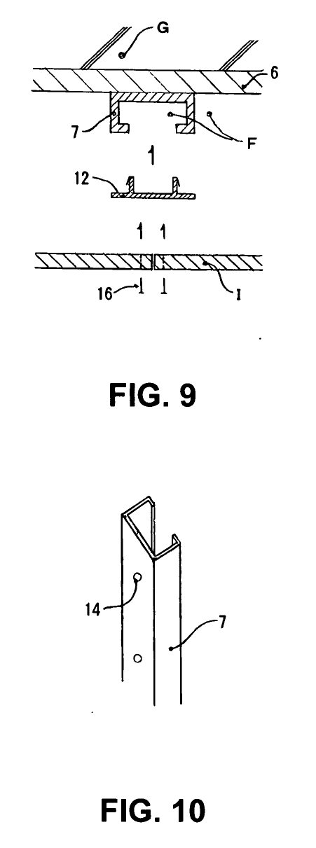

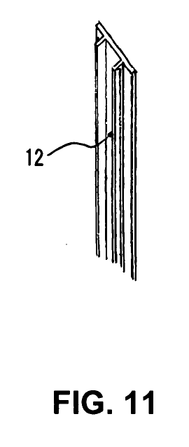

Then, as shown in FIG. 6, the form panel 1 has a plurality of form tie holes 13 at specified intervals in the longitudinal grooves 8. In addition, as shown in FIG. 10, the substrate member 7 for interior and exterior materials has a plurality of separator holes 14 at specified intervals, and the form panel 5 is secured with nuts 15 via the separator C while fitting in the longitudinal grooves 4. After curing the concrete, the form support is dissembled, and as shown in FIG. 9, the fastening receiving material 12 shown in FIG. 11 is inserted in the substrate member 7 for interior and exterior materials and the interior and exterior materials I are attached with the fastening material 16.

According to the form panel 6 of the invention, the outer form 9, the stiffeners 10, and the reinforcing stiffeners 11 as the longitudinal grooves 8 are mounted on the heat insulation board 2 and the substrate member 7 for interior and exterior materials. Accordingly, through the their synergetic effects, the form panel 6 can increase a bending strength of the sheathing, and can be also used as a vertical lumber. Accordingly, by fastening the separators C, on which a horizontal lumber E is arranged, with form ties H, it becomes durable against the side pressure from the concrete G.

In addition, the form panel 6 has a configuration so as to be used on the both sides of the concrete casting surface. Furthermore, depending on a use, any type of conventional form board P can be additionally used on one side.

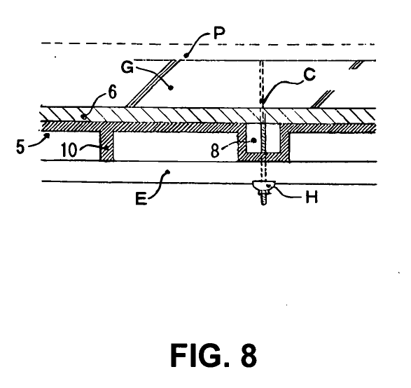

Furthermore, for materials of the form panel 6, the substrate member 7 for interior and exterior materials, and the fastening receiving material 12, steel and plastic are preferred. The materials and shapes can be arbitrary as long as they satisfy suitable criteria for simplification of the construction, possible frequency for recycling, reduction of weight, etc. Furthermore, as far as the strength of the form panel 6 is sufficient, concrete can be cast without engaging the substrate member 7 for interior and exterior materials in the longitudinal grooves 8 as shown in FIG. 8.

1-3. (canceled)

4. A form panel doubling as a substrate for interior and exterior materials, comprising:
a sheathing of a concrete form including a plurality of longitudinal grooves having a rectangular cross-section in a surface thereof, said sheathing being formed of a plastic board; and
a substrate member for interior and exterior materials having a square bar shape and fitted in the longitudinal grooves, said longitudinal groove including bottoms having at least one through hole, said substrate member for interior and exterior materials including another through hole connecting to the through hole when the substrate member for interior and exterior materials engages in the longitudinal grooves.

5-8. (canceled)

9. A form construction method for a concrete structure, comprising:
a substrate member for interior and exterior materials securing step of fitting and securing a substrate member for interior and exterior materials having a square bar shape in a plurality of longitudinal grooves of a sheathing of a concrete form including the plurality of longitudinal grooves having a rectangular cross-section in a surface thereof;
a heat insulation board securing step of securing a heat insulation board on a concrete casting surface;
a form securing step of securing a concrete form with the substrate for interior and exterior materials secured thereon on a backside of the heat insulating board;
a casting concrete step of casting concrete; and
a concrete form removing step of dissembling and removing a concrete form from a concrete framework, while leaving the substrate member for interior and exterior materials in the concrete framework,
wherein said longitudinal grooves of the concrete form include bottoms having a specified through hole, and said substrate member for interior and exterior materials includes a through hole connecting to the specified through hole when the substrate member for interior and exterior materials is fitted in the longitudinal grooves,
after the heat insulation board securing step and the form securing step, further comprising a separator securing step of securing a separator with a nut through the specified through hole and the through hole to be embedded in at least a concrete framework to be cast.

10. The form construction method for a concrete structure according to claims 9, further comprising an unevenness adjusting step of adjusting the nut securing the separator and placing an intervening material between the heat insulation board and the substrate member for interior and exterior materials to secure. cm 11. A form construction method for a concrete structure, comprising:
a substrate member for interior and exterior materials securing step of fitting and securing a substrate member for interior and exterior materials having a square bar shape in a plurality of longitudinal grooves of a sheathing of a concrete form including the plurality of longitudinal grooves having a rectangular cross-section in a surface thereof;
a heat insulation board securing step of securing a heat insulation board on a concrete casting surface;
a form securing step of securing a concrete form with the substrate for interior and exterior materials secured thereon on a backside of the heat insulating board;
a casting concrete step of casting concrete; and
a concrete form removing step of dissembling and removing a concrete form from a concrete framework, while leaving the substrate member for interior and exterior materials in the concrete framework,
wherein said substrate member for interior and exterior materials is formed of C-form steel, in the substrate member for interior and exterior materials securing step, said substrate member for interior and exterior materials being secured so that an opening thereof faces bottoms of the longitudinal grooves, after the concrete form removing step, further comprising a fastening receiving material securing step of fitting a fastening receiving material formed of a board having a width substantially same as that of the substrate member for interior and exterior materials to the opening.
